(19) United States
(12) Patent Application Publication
(10) Pub. No.: US 2026/0248148 A1
(43) Pub. Date: Aug. 27, 2026

(54) SMOKER, SMOKING DEVICE AND GRILL

(71) Applicant: MONUMENT GRILL LLC, Lewes, DE (US)

(72) Inventors: Luoda Ying, CIXI (CN); Xiaopeng Fang, CIXI (CN); Chao Fu, CIXI (CN); Xianghua Liu, CIXI (CN); Xuefei Mao, CIXI (CN)

(21) Appl. No.: 19/649,072

(22) Filed: Apr. 15, 2026

(30) Foreign Application Priority Data
Mar. 12, 2026 (CN) 202620303650.1

(51) Int. Cl. A23B 4/052; A47J 37/07

(52) U.S. Cl. CPC A23B 4/052; A47J 37/0713; A47J 37/0786

(57) ABSTRACT

A smoker, a smoking device and a grill, by providing a detachable container detachably mounted on a fixed carrier, in a smoking state, a first air inlet hole and a second air inlet hole are in communication with each other, so that air outside the fixed carrier sequentially passes through the first air inlet hole and the second air inlet hole and enters a fuel chamber, while smoke generated by combustion in the fuel chamber enters a smoke output functional area; in a detached state, the detachable container and the fixed carrier are separately provided; realizing that the smoker is not only capable of being stably assembled and used, but also the detachable container is capable of being conveniently removed for cleaning and filling.

### TECHNICAL FIELD

The present invention relates to the field of grill devices, and specifically relates to a smoker, a smoking device and a grill.

### BACKGROUND

A smoker is used for adding smoke flavor to food. In cooking, smoking is a commonly used technique. By burning wood of different trees in the smoker, different wood odors are obtained, which can provide a unique fragrance and different flavors for the food.

Existing smokers are all of an openable and closable box-like structure provided with holes on a surface of the box-like structure. By opening the box body and placing wood into the box body for combustion, after the box body is closed by a box cover, the box body is directly placed in a grill for use, and smoke burned in the box body is guided out by means of an air flow to be used for smoking.

The shortcomings of the existing smokers lie in that: since the smoker is directly placed in the grill, the stability of the smoker is poor, and the smoker is prone to moving during use to cause danger.

### SUMMARY

In view of the shortcomings existing in the prior art, an objective of the present invention is to provide a smoker, a smoking device and a grill for realizing that the smoker is not only capable of being stably assembled and used, but also the detachable container is capable of being conveniently removed for cleaning and filling by providing a detachable container detachably mounted on a fixed carrier.

To realize the above objective, the present invention provides the following technical solutions, comprising: a fixed carrier, the fixed carrier being provided with an assembly chamber, a first air inlet hole and a smoke output functional area; a detachable container, the detachable container being provided with a fuel chamber and a second air inlet hole that are in communication with each other; the smoker having a smoking state and a detached state; in the smoking state, at least a portion of the detachable container is assembled into the assembly chamber, and the second air inlet hole is located in the assembly chamber, the first air inlet hole and the second air inlet hole are in communication with each other, so that air outside the fixed carrier sequentially passes through the first air inlet hole and the second air inlet hole and enters the fuel chamber, the fuel chamber and the smoke output functional area are in communication with each other, so that smoke generated by combustion in the fuel chamber enters the smoke output functional area; and in the detached state, the detachable container and the fixed carrier are separately provided.

A smoking device comprises: the smoker described above; and an air blowing device, the air blowing device being used for realizing air blowing from the air blowing channel toward the smoke output channel.

A grill comprises: a grill frame, the grill frame being provided with a grilling area; the smoker described above, or, the smoking device described above, wherein the fixed carrier is provided on the grill frame, and smoke in the smoke output functional area is diverted to the grilling area to smoke food in the grilling area.

By adopting the above technical solutions: 1. The fixed carrier is mountable on a device used in combination with the smoker, such as a grill, and when the smoker is required for use, a smoking state is formed by filling the fuel chamber of the detachable container with burning wood and then mounting the detachable container to the fixed carrier. At this time, the burning wood generates smoke in the fuel chamber, and due to the communication between the fuel chamber and the smoke output functional area, the smoke can enter the smoke output functional area, and under the action of the smoke output functional area, the smoke is discharged. In addition, the discharge of smoke from the smoke output functional area forms a negative pressure in the fuel chamber, so that the air outside the fixed carrier can be sucked into the fuel chamber sequentially through the first air inlet hole and the second air inlet hole to provide oxygen and ensure sufficient combustion. This operation ensures stability of the smoker, thereby improving safety of use. 2. When the smoker is not required for use, a detached state can be formed by detaching the detachable container from the fixed carrier. Since the wood is placed in the fuel chamber, the detachment of the detachable container is convenient for removal and replacement of the wood, and is convenient for cleaning the detachable container.

### BRIEF DESCRIPTION OF THE DRAWINGS

FIG. 1 is an assembly view of Embodiment 1 of the present invention in a smoking state;

FIG. 2 is a sectional view of Embodiment 1 of the present invention in a smoking state;

FIG. 3 is an assembly view of Embodiment 1 of the present invention in an ignition state;

FIG. 4 is an assembly view of Embodiment 1 of the present invention in a detached state;

FIG. 5 is an assembly view of a detachable container in Embodiment 1 of the present invention;

FIG. 6 is an exploded view of an access cover in Embodiment 1 of the present invention;

FIG. 7 is an enlarged view of A in FIG. 2;

FIG. 8 is an assembly view of Embodiment 2 of the present invention;

FIG. 9 is an assembly view of Embodiment 3 of the present invention;

FIG. 10 is an assembly view of Embodiment 3 of the present invention;

FIG. 11 is an assembly view of a side table in Embodiment 3 of the present invention;

FIG. 12 is an assembly view of Embodiment 4 of the present invention;

FIG. 13 is an assembly view of Embodiment 4 of the present invention;

FIG. 14 is a schematic diagram of another embodiment of the present invention.

### DETAILED DESCRIPTION OF THE DISCLOSURE

### Embodiment 1:

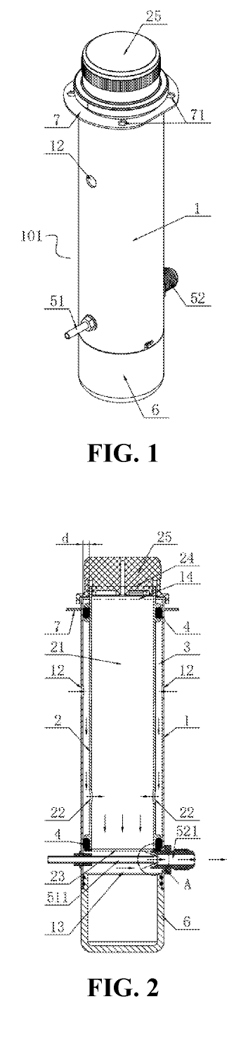

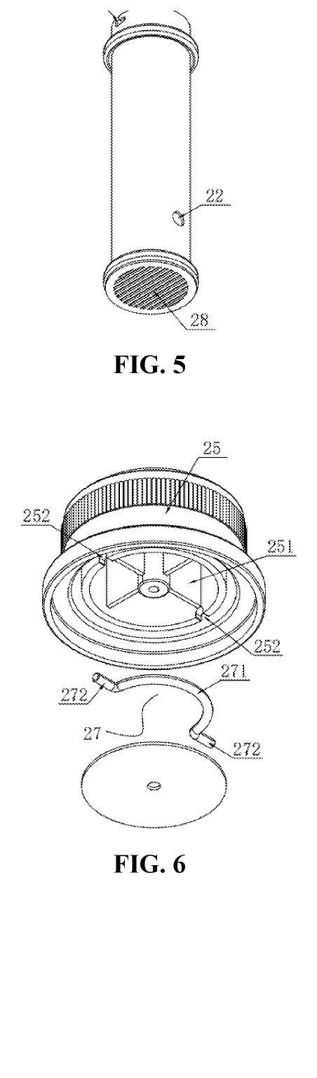

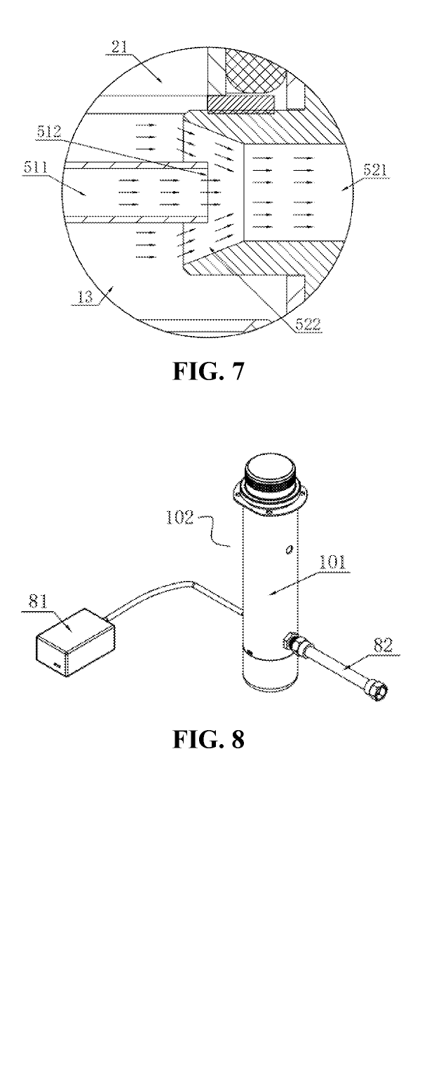

As shown in FIG. 1 to FIG. 7, the present invention discloses a smoker 101, comprising:

a fixed carrier 1, wherein a fixed carrier 1 is provided in a cylindrical shape, the fixed carrier 1 is provided with an assembly chamber 11, a first air inlet hole 12 and a smoke output functional area 13, wherein the assembly chamber 11 and the smoke output functional area 13 are both provided in a columnar shape, and the assembly chamber 11 is at an upper side and the smoke output functional area 13 is at a lower side, the first air inlet hole 12 is provided through a peripheral wall of the fixed carrier 1, so that the assembly chamber 11 and an outside of the fixed carrier 1 are in communication with each other through the first air inlet hole 12;

a detachable container 2, wherein the detachable container 2 is also provided in a cylindrical shape, the detachable container 2 is provided with a fuel chamber 21 and a second air inlet hole 22, wherein the fuel chamber 21 is provided in a columnar shape, the second air inlet hole 22 is provided through a peripheral wall of the detachable container 2, so that the fuel chamber 21 and an outside of the detachable container 2 are in communication with each other through the second air inlet hole 22;

wherein the smoker 101 has a smoking state shown in FIG. 1 to FIG. 2 and a detached state shown in FIG. 4;

in the smoking state, at least a portion of the detachable container 2 is assembled into the assembly chamber 11, and the second air inlet hole 22 is located in the assembly chamber 11, the first air inlet hole 12 and the second air inlet hole 22 are in communication with each other, so that air outside the fixed carrier 1 sequentially passes through the first air inlet hole 12 and the second air inlet hole 22 and enters the fuel chamber 21, the fuel chamber 21 and the smoke output functional area 13 are in communication with each other, so that smoke generated by combustion in the fuel chamber 21 enters the smoke output functional area 13;

in the detached state, the detachable container 2 and the fixed carrier 1 are separately provided.

Therefore, 1. the fixed carrier 1 is mountable on a device used in combination with the smoker 101, such as a grill, and when the smoker 101 is required for use, a smoking state is formed by filling the fuel chamber 21 of the detachable container 2 with burning wood and then mounting the detachable container 2 to the fixed carrier 1. At this time, the burning wood generates smoke in the fuel chamber 21, and due to communication between the fuel chamber 21 and the smoke output functional area 13, the smoke can enter the smoke output functional area 13, and under the action of the smoke output functional area 13, the smoke is discharged. In addition, the discharge of smoke from the smoke output functional area 13 forms a negative pressure in the fuel chamber 21, so that the air outside the fixed carrier 1 can be sucked into the fuel chamber 21 sequentially through the first air inlet hole 12 and the second air inlet hole 22 to provide oxygen and ensure sufficient combustion. This operation ensures stability of the smoker 101, thereby improving safety of use. 2. When the smoker 101 is not required for use, a detached state can be formed by detaching the detachable container 2 from the fixed carrier 1. Since the wood is placed in the fuel chamber 21, the detachment of the detachable container 2 is convenient for removal and replacement of the wood, and is convenient for cleaning the detachable container 2.

Wherein, in the smoking state, a diversion interlayer 3 is formed between an outer wall of the detachable container 2 and an inner wall of the assembly chamber 11, so that air outside the fixed carrier 1 sequentially passes through the first air inlet hole 12, the diversion interlayer 3 and the second air inlet hole 22 to enter the fuel chamber 21.

Therefore, 1. under the diversion interlayer 3, the detachable container 2 and the fixed carrier 1 are provided in a non-direct contact manner, so that a temperature of the fixed carrier 1 is lower, making the use safer, and outside air needs to pass through the diversion interlayer 3 for pre-heating before entering the fuel chamber 21, which prevents air with a lower outside temperature from directly entering the fuel chamber 21 to cause thermal energy loss; 2. wood combustion in the fuel chamber 21 may generate a flame at the second air inlet hole 22, and the diversion interlayer 3 increases a distance between the first air inlet hole 12 and the second air inlet hole 22, so that the flame at the second air inlet hole 22 is not easy to burn to the first air inlet hole 12, so that no open flame is generated outside the fixed carrier 1, thereby ensuring safety of use; 3. the provision of the diversion interlayer 3 makes a travel of outside air entering the fuel chamber 21 longer, so that air supply is slower to reduce an air supply rate, thereby increasing a wood combustion duration, i.e., extending a smoke output time to improve an overall use effect.

Wherein, a thickness of the diversion interlayer 3 is d, wherein d ≤ 15 mm, so that the diversion interlayer 3 with a smaller thickness further reduces the air supply rate and increases the wood combustion duration, i.e., extending the smoke output time to improve the overall use effect.

Wherein, the detachable container 2 in the present embodiment is assembled with and detached from the fixed carrier 1 by means of insertion.

Preferably, the diversion interlayer 3 is provided in a cylindrical shape. The first air inlet hole 12 and the second air inlet hole 22 in the present embodiment are provided in a staggered arrangement along the longitudinal direction of the diversion interlayer 3 to prevent an open flame from being generated at the first air inlet hole 12 and increase a diversion travel of air.

In other embodiments, the first air inlet hole 12 and the second air inlet hole 22 may be provided in a staggered arrangement along a circumferential direction of the diversion interlayer 3, which can also prevent an open flame from being generated at the first air inlet hole 12 and increase the diversion travel of air.

Preferably, the first air inlet hole 12 is provided through the fixed carrier 1 in a thickness direction of a side wall of the fixed carrier 1, and the second air inlet hole 22 is provided through the detachable container 2 in a thickness direction of a side wall of the detachable container 2, so that in the smoking state, the first air inlet hole 12 is provided toward an outer wall of the detachable container 2, and the second air inlet hole 22 is provided toward an inner wall of the assembly chamber 11. The advantages thereof are that a structure is simpler, and the first air inlet hole 12 and the second air inlet hole 22 are not provided to face each other, so that air diversion resistance is greater to reduce a flow rate, and an open flame at the second air inlet hole 22 is less likely to burn to the first air inlet hole 12.

Preferably, each of the first air inlet hole 12 and the second air inlet hole 22 is provided in plurality, and all are arranged in the circumferential direction, so that air supply to the wood is more uniform to make the wood burn more completely. In the present embodiment, two first air inlet holes 12 and two second air inlet holes 22 are provided.

Furthermore, a sealing portion 4 is snapped at each of upper and lower positions of an outer periphery of the detachable container 2, so that in the smoking state, the sealing portion 4 closes two longitudinal ends of the diversion interlayer 3. Specifically, the sealing portion 4 may be made of high-temperature resistant ceramic, high-temperature resistant rubber, or the like, so that a more stable air inlet channel is formed and air supply is effectively controlled to make combustion more stable.

In other embodiments, the sealing portion 4 may also be provided on the fixed carrier 1.

Wherein, a lower end of the fuel chamber 21 is provided with a smoke outlet 23; in the smoking state, the smoke outlet 23, the second air inlet hole 22 and the first air inlet hole 12 are sequentially arranged upward. Therefore, in a case where the first air inlet hole 12 and the second air inlet hole 22 maintain a large distance, after wood is filled in the fuel chamber 21, oxygen is supplied to the wood through the second air inlet hole 22 at a lower side, so that the wood at the lower side burns preferentially, and smoke generated by combustion can be supplied to the smoke output functional area 13 through the smoke outlet 23 at the lower side. After the wood at the lower side burns, the wood at upper side falls under the action of gravity to perform supplementary combustion, so that the wood burns more sufficiently.

Specifically, an upper end of the assembly chamber 11 is provided with an opening, so that the upper end of the assembly chamber 11 is provided with a first assembly opening 14. The detachable container 2 is inserted into the assembly chamber 11 through the first assembly opening 14 to form a smoking state, or is removed from the assembly chamber 11 to form a detached state, making the use more convenient.

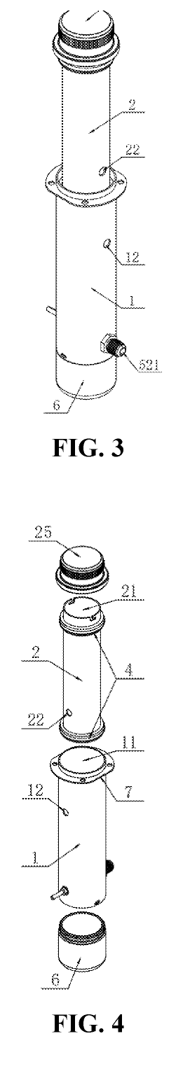

Furthermore, the smoker 101 also includes an ignition state shown in FIG. 3; in the ignition state, at least a portion of the detachable container 2 is assembled into the assembly chamber 11, and the second air inlet hole 22 is located outside the assembly chamber 11, the fuel chamber 21 and the smoke output functional area 13 are in communication with each other, so that smoke generated by combustion in the fuel chamber 21 enters the smoke output functional area 13. In addition, the detachable container 2 is slidably inserted downward into the assembly chamber 11, so that the second air inlet hole 22 enters the assembly chamber 11 through the first assembly opening 14 to switch the smoker 101 from the ignition state to the smoking state.

Therefore, the smoker 101 can be adjusted to the ignition state, and unignited wood or insufficiently ignited wood can be further ignited by directly supplying an open flame to the exposed second air inlet hole 22, ensuring that the wood can burn completely and continuously when the smoker 101 is subsequently adjusted to the smoking state. Moreover, since a portion of the detachable container 2 is placed in the assembly chamber 11, during an ignition process, the operation of the smoke output functional area 13 can make smoke generated in the fuel chamber 21 enter the smoke output functional area 13 through the assembly chamber 11, reducing or even eliminating overflow of smoke during the ignition process to make use experience better.

Wherein, the smoke output functional area 13 and the first assembly opening 14 are located on opposite sides of the assembly chamber 11.

Furthermore, a top of the detachable container 2 is provided with a filling opening 24 and an access cover 25 for opening or closing the filling opening 24. In the smoking state, the access cover 25 is located at the first assembly opening 14.

Therefore, when wood is insufficient, there is no need to take out the detachable container 2, and the wood can be supplemented by directly opening the access cover 25 and through the filling opening 24, which makes the use more convenient.

Wherein, the top of the detachable container 2 is provided with two L-shaped notches 26, and a fastener 27 is provided in the access cover 25. Specifically, the fastener 27 includes a C-shaped intermediate segment 271 and fastening segments 272 located at two ends of the intermediate segment 271. An inner cavity 251 in a circular shape is provided in the access cover 25, and two outward notches 252 are provided through a side wall of the inner cavity 251, so that the intermediate segment 271 is arranged in the inner cavity 251 and remains stable under limitation of a peripheral wall of the inner cavity 251. The two fastening segments 272 extend out from different outward notches 252, and then assembly and detachment of the access cover 25 and the detachable container 2 can be realized through cooperation of the two fastening segments 272 and the two L-shaped notches 26.

In other embodiments, the access cover 25 may also be detachably mounted on the detachable container 2 by means of threaded connection or the like.

Wherein, a peripheral size of the access cover 25 is greater than a peripheral size of the fixed carrier 1, so that a positioning effect is achieved by the access cover 25 abutting against a top of the fixed carrier 1.

Preferably, in the present embodiment, the smoke output functional area 13 is provided with an air blowing tube 51 and a smoke output tube member 52. The air blowing tube 51 passes through an outer wall of the fixed carrier 1 from an outside of the fixed carrier 1 to enter the smoke output functional area 13, and the smoke output tube member 52 is mounted on the fixed carrier 1, so that an end of the smoke output tube member 52 is located on the outside of the fixed carrier 1, and an end of the smoke output tube member 52 is located in the smoke output functional area 13. Wherein, a channel of the air blowing tube 51 serves as an air blowing channel 511, and a channel of the smoke output tube member 52 serves as a smoke output channel 521. An end of the air blowing channel 511 in the smoke output functional area 13 faces an end of the smoke output channel 521 in the smoke output functional area 13, so that through the air blowing channel 511 continuously blowing air toward the smoke output channel 521, a Bernoulli principle is adopted to realize that smoke in the smoke output functional area 13 is sucked into the smoke output channel 521 and then diverted and discharged.

Preferably, in the present embodiment, an end of the smoke output channel 521 facing the air blowing channel 511 is provided with an accelerated injection section 522. The accelerated injection section 522 is provided in a flared shape away from the smoke output channel 521, so that under action of the accelerated injection section 522, the smoke in the smoke output functional area 13 can be more rapidly sucked into the smoke output channel 521.

Wherein, in the present embodiment, an end of the air blowing channel 511 facing the smoke output channel 521 serves as an air blowing port 512. The air blowing channel 511 partially extends into the accelerated injection section 522, so that the air blowing port 512 is located in the accelerated injection section 522, so that an air flow blown from the air blowing port 512 is located in the accelerated injection section 522, and more completely enters the smoke output channel 521 under diversion of the accelerated injection section 522, which prevents the air flow blown from the air blowing port 512 from diffusing to generate turbulent flow with the sucked smoke, thereby further improving an effect of sucking the smoke in the smoke output functional area 13 into the smoke output channel 521.

Preferably, an inward extension distance of the air blowing port 512 is less than or equal to 5 mm.

As shown in FIG. 14, in other embodiments, the air blowing channel 511 may also be provided outside the accelerated injection section 522. A distance between the air blowing channel 511 and the accelerated injection section 522 is s, wherein 0 ≤ s ≤ 15 mm, so that through a small distance, the air flow blown from the air blowing channel 511 can also completely enter the smoke output channel 521 to ensure the effect of sucking the smoke in the smoke output functional area 13 into the smoke output channel 521.

Furthermore, an ash collection box 6 is detachably provided at a bottom of the fixed carrier 1. An assembly chamber 11, the air blowing channel 511/smoke output channel 521 and the ash collection box 6 are sequentially arranged downward, so that the ash collection box 6 is used for collecting wood ash that falls after being burned in the fuel chamber 21, and the ash collection box 6 is detached for treatment of the wood ash after a certain amount of the wood ash is collected.

Furthermore, in the present embodiment, the detachable container 2 is provided with a filter screen 28 at a smoke outlet 23, so that wood is unable to escape from the fuel chamber 21 to ensure sufficiency of combustion of the wood in the fuel chamber 21, and the wood ash after the wood is burned can pass over the filter screen 28 and be collected in the ash collection box 6, and the wood ash is treated through detachment of the ash collection box 6.

Preferably, a clearance range of the filter screen 28 is in a range of 1 mm to 5 mm.

The ash collection box 6 in the present embodiment is detachably mounted on the fixed carrier 1 by means of threaded connection, buckle or the like.

Wherein, a mounting portion 7 in an annular shape is provided on a peripheral wall of an upper end of the fixed carrier 1. A plurality of mounting holes 71 are provided along a circumferential direction on the mounting portion 7, so that a structure requiring mounting is abutted by the mounting portion 7, and then fixed mounting of the fixed carrier 1 is performed through bolts or the like in cooperation with the mounting holes 71.

### Embodiment 2:

As shown in FIG. 8, the present invention further discloses a smoking device 102, comprising:

the smoker 101 described in embodiment 1; and

an air blowing device 81, the air blowing device 81 being used for realizing air blowing from the air blowing channel 511 toward the smoke output channel 521.

Specifically, the air blowing device 81 adopts an air blowing pump. The air blowing pump and the air blowing tube 51 are connected by a conduit, so that when the air blowing pump is started, air can be continuously supplied to the air blowing channel 511 through the air blowing pump, so that the air blowing from the air blowing channel 511 enters the smoke output channel 521 to suck away smoke in the smoke output functional area 13.

Furthermore, a smoke output conduit 82 is further included. The smoke output conduit 82 is located on the outside of the fixed carrier 1, one end of the smoke output conduit 82 is connected to the smoke output channel 521, and the other end is used for guiding and discharging the smoke.

Thus, the smoke is precisely guided to a position required for smoking through the smoke output conduit 82 to perform smoking.

### Embodiment 3:

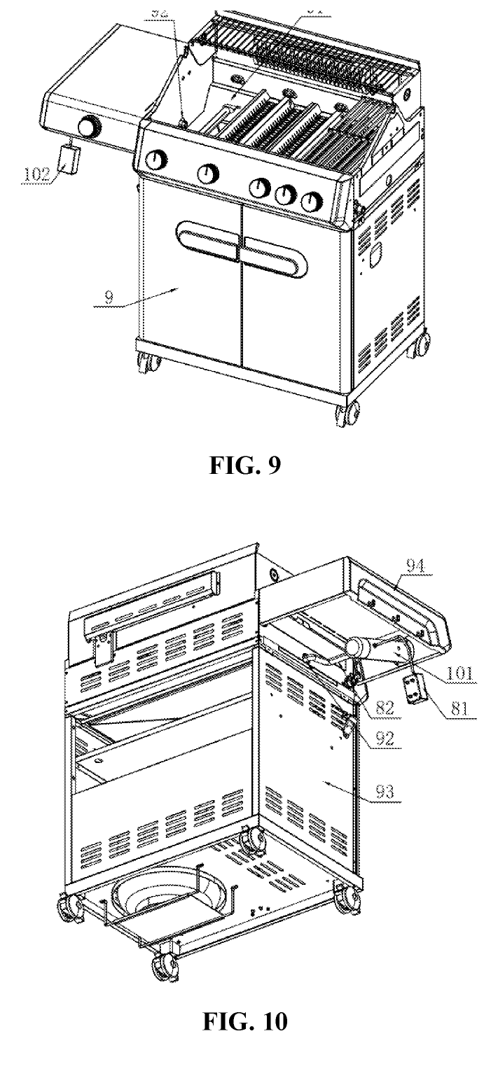

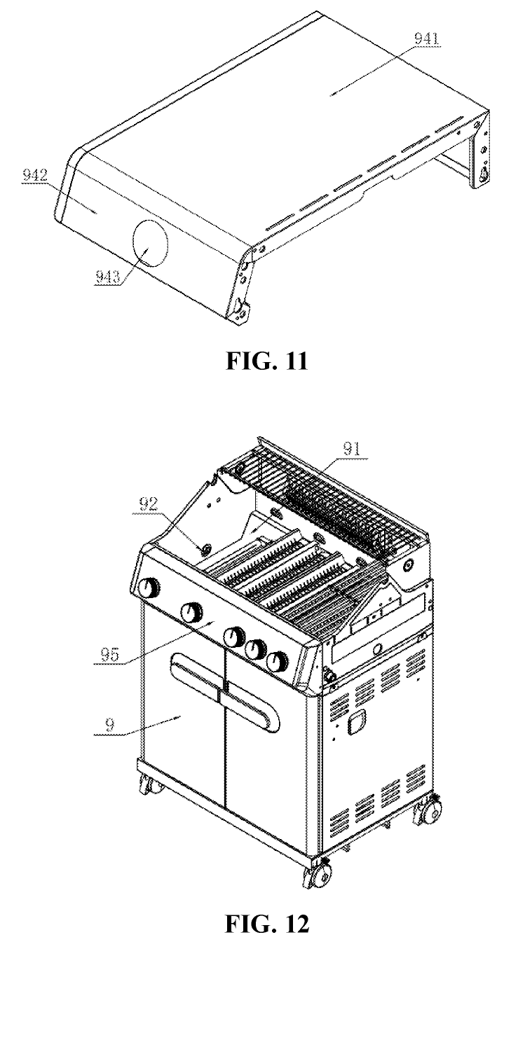

As shown in FIG. 9 to FIG. 11, the present invention further discloses a grill, comprising:

a grill frame 9, the grill frame 9 being provided with a grilling area 91 opening upward, a gas pipeline or the like being provided in the grilling area 91, and a cooking grate or the like being provided at a top of the grilling area 91; and

the smoking device 102 described in embodiment 2, wherein the mounting portion 7 is mounted on the grill frame 9 by means of bolts to realize mounting of the fixed carrier 1, and smoke in the smoke output functional area 13 is diverted to the grilling area 91 to smoke food in the grilling area 91.

Specifically, the grill frame 9 includes a main frame 93 and a side table 94. The grilling area 91 is provided on the main frame 93, the side table 94 is provided on either the left or right side of the main frame 93, and the fixed carrier 1 is provided on the side table 94. In addition, a smoke inlet hole 92 is provided on a side wall of the main frame 93, so that an end of the smoke output conduit 82 away from the smoke output channel 521 is inserted into the grilling area 91 through the smoke inlet hole 92 to more fully utilize smoke for smoking.

Specifically, the side table 94 includes an upper storage platform 941 and a front control panel 942. The fixed carrier 1 is mounted at a rear side of the control panel 942, and the fixed carrier 1 is located below the storage platform 941 and at the rear side of the control panel 942. In addition, a second assembly opening 943 is provided on the control panel 942, and the second assembly opening 943 is for the detachable container 2 to pass rearward through the control panel 942 to be assembled with the fixed carrier 1 or pass forward through the control panel 942 to be detached from the fixed carrier 1.

Therefore, the storage platform 941 can be utilized for placing items, making grilling operation more convenient. A setting position of the fixed carrier 1 makes the fixed carrier 1 not easy to be contacted, making use safer. Through provision of the second assembly opening 943, assembly and detachment of the detachable container 2 can be conveniently performed, which further improves convenience of operation.

Preferably, in the smoking state, the fuel chamber 21 is provided in a rearward and downward inclined manner, so that wood placed in the fuel chamber 21 can fall under action of gravity to be supplemented to a bottom of the fuel chamber 21, so that the wood burns more sufficiently.

In addition, in the smoking state, the access cover 25 is located at the front side of the control panel 942, so that operation of the access cover 25 is conveniently performed to open the fuel chamber 21 for adding wood.

### Embodiment 4:

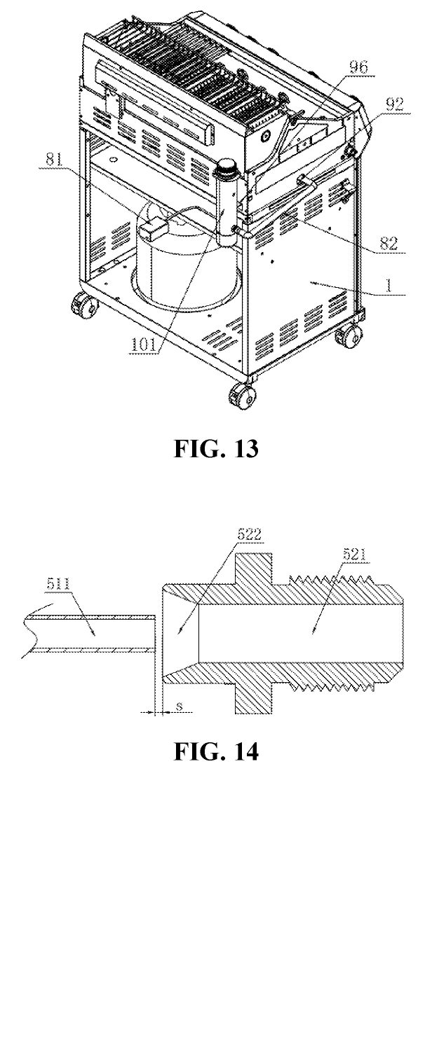

As shown in FIG. 12 to FIG. 13, the present invention further discloses a grill, comprising:

a grill frame 9, the grill frame 9 being provided with a grilling area 91 opening upward, a gas pipeline or the like being provided in the grilling area 91, and a cooking grate or the like being provided at a top of the grilling area 91; and

the smoking device 102 described in embodiment 2, wherein the mounting portion 7 is mounted on the grill frame 9 by means of bolts, welding or the like to realize mounting of the fixed carrier 1, and smoke in the smoke output functional area 13 is diverted to the grilling area 91 to smoke food in the grilling area 91.

Preferably, an operation area 95 is provided at a front side of the grill frame 9, and the fixed carrier 1 is provided at a rear side of the grill frame 9. Specifically, a U-shaped member 96 is mounted at the rear side of the grill frame 9 by means of welding, bolts or the like. One side of the U-shaped member 96 is fixed to the grill frame 9, and the other side of the U-shaped member 96 is fixed to an outer wall of the fixed carrier 1.

Therefore, the setting position of the fixed carrier 1 makes the fixed carrier 1 not easy to be contacted, making use safer.

Preferably, the access cover 25 is provided at a top of the detachable container 2, so that wood placed in the fuel chamber 21 can fall under action of gravity to be supplemented to the bottom of the fuel chamber 21, so that the wood burns more sufficiently.

Wherein, the smoke inlet hole 92 is provided on a side wall of the grill frame 9, so that an end of the smoke output conduit 82 away from the smoke output channel 521 is inserted into the grilling area 91 through the smoke inlet hole 92 to more fully utilize smoke for smoking.

What is claimed is:

1. A smoker, comprising: a fixed carrier, the fixed carrier being provided with an assembly chamber, a first air inlet hole and a smoke output functional area; anda detachable container, the detachable container being provided with a fuel chamber and a second air inlet hole that are in communication with each other;
wherein the smoker has a smoking state and a detached state; in the smoking state, the detachable container is at least partially assembled into the assembly chamber, and the second air inlet hole is located in the assembly chamber, the first air inlet hole and the second air inlet hole are in communication with each other, so that air outside the fixed carrier sequentially passes through the first air inlet hole and the second air inlet hole and enters the fuel chamber, and wherein the fuel chamber and the smoke output functional area are in communication with each other, so that smoke generated by combustion in the fuel chamber enters the smoke output functional area; and in the detached state, the detachable container and the fixed carrier are separately provided.

2. The smoker according to claim 1, wherein: in the smoking state, a diversion interlayer is formed between an outer wall of the detachable container and an inner wall of the assembly chamber, so that the air outside the fixed carrier sequentially passes through the first air inlet hole, the diversion interlayer and the second air inlet hole and enters the fuel chamber.

3. The smoker according to claim 2, wherein: the assembly chamber and the outer wall of the detachable container are both provided in a columnar shape;
in the smoking state, the detachable container is inserted in the assembly chamber, so that the diversion interlayer is provided in a cylindrical shape, and the first air inlet hole and the second air inlet hole are provided in a staggered arrangement along a longitudinal direction and/or a circumferential direction of the diversion interlayer.

4. The smoker according to claim 3, wherein: in the smoking state, the first air inlet hole is provided toward the outer wall of the detachable container, and the second air inlet hole is provided toward the inner wall of the assembly chamber; each of the first air inlet hole and the second air inlet hole is provided in plurality; and at least one of the fixed carrier and the detachable container is provided with a sealing portion, in the smoking state, the sealing portion closes two longitudinal ends of the diversion interlayer.

5. The smoker according to claim 2, wherein: a lower end of the fuel chamber is provided with a smoke outlet;
in the smoking state, the smoke outlet, the second air inlet hole and the first air inlet hole are sequentially arranged upward.

6. The smoker according to claim 1, wherein: one end of the assembly chamber is provided with a first assembly opening, the first assembly opening being for the detachable container to be inserted into or removed from the assembly chamber.

7. The smoker according to claim 6, wherein: the smoker further comprises an ignition state; in the ignition state, the detachable container is at least partially assembled into the assembly chamber, and the second air inlet hole is located outside the assembly chamber, and wherein the fuel chamber and the smoke output functional area are in communication with each other, so that the smoke generated by combustion in the fuel chamber enters the smoke output functional area; and the detachable container is slidably inserted into the assembly chamber, so that the second air inlet hole enters the assembly chamber through the first assembly opening to switch the smoker from the ignition state to the smoking state.

8. The smoker according to claim 6, wherein: the smoke output functional area and the first assembly opening are located on opposite sides of the assembly chamber; and
the detachable container is provided with a filling opening and an access cover for opening or closing the filling opening,
in the smoking state, the access cover is located at the first assembly opening.

9. The smoker according to claim 1, wherein: the smoke output functional area is provided with an air blowing channel and a smoke output channel, the air blowing channel being used for blowing air toward the smoke output channel to suck smoke in the smoke output functional area into the smoke output channel.

10. The smoker according to claim 9, wherein: an end of the smoke output channel toward the air blowing channel is provided with an accelerated injection section, the accelerated injection section being provided in a flared shape away from the smoke output channel.

11. The smoker according to claim 10, wherein: the air blowing channel is provided with an air blowing port, the air blowing channel partially extending into the accelerated injection section, so that the air blowing port is located in the accelerated injection section.

12. The smoker according to claim 9, wherein: the fixed carrier is detachably provided with an ash collection box, the ash collection box being located on a side of at least one of the air blowing channel and the smoke output channel away from the assembly chamber.

13. A smoking device, comprising: the smoker according to claim 9; and an air blowing device, the air blowing device being used for realizing air blowing from the air blowing channel toward the smoke output channel.

14. The smoking device according to claim 13, wherein: the air blowing device uses an air blowing pump;
and the smoking device further comprises a smoke output conduit, the smoke output conduit being located on the outside of the fixed carrier, one end of the smoke output conduit being connected to the smoke output channel, and the other end being used for guiding and discharging the smoke.

16. The grill according to claim 15, wherein: the grill frame comprises a main frame and a side table, the grilling area being provided on the main frame, the side table being provided on either the left or right side of the main frame, and the fixed carrier being provided on the side table.

15. A grill, comprising: a grill frame, the grill frame being provided with a grilling area; and the smoker according to claim 1, or, the smoking device according to claim 13, wherein the fixed carrier is provided on the grill frame, and the smoke in the smoke output functional area is diverted to the grilling area to smoke food in the grilling area.

17. The grill according to claim 16, wherein: the side table comprises an upper storage platform and a front control panel, the fixed carrier being mounted on the control panel, and the fixed carrier being located below the storage platform and at a rear side of the control panel; and
the control panel is provided with a second assembly opening, the second assembly opening being for the detachable container to pass rearward through the control panel to be assembled with the fixed carrier or pass forward through the control panel to be detached from the fixed carrier.

18. The grill according to claim 17, wherein: in the smoking state, the fuel chamber is provided in a rearward and downward inclined manner; and
the detachable container is provided with a filling opening and an access cover for opening or closing the filling opening,
in the smoking state, the access cover is located at the front side of the control panel.

19. The grill according to claim 15, wherein: a front side of the grill frame is provided with an operation area, and the fixed carrier is provided on the rear side of the grill frame.

20. The grill according to claim 19, wherein: a top of the detachable container is provided with a filling opening and an access cover for opening or closing the filling opening.
